(19) United States
(12) Patent Application Publication
(10) Pub. No.: US 2023/0318730 A1
(43) Pub. Date: Oct. 5, 2023

(54) COMMUNICATION DEVICE, COMMUNICATION METHOD, COMMUNICATION SYSTEM AND COMMUNICATION PROGRAM

(71) Applicant: NIPPON TELEGRAPH AND TELEPHONE CORPORATION, Tokyo (JP)

(72) Inventors: Takamitsu TOCHINO, Musashino-shi, Tokyo (JP); Hirotaka UJIKAWA, Musashino-shi, Tokyo (JP); Hirotaka NAKAMURA, Musashino-shi, Tokyo (JP)

(73) Assignee: NIPPON TELEGRAPH AND TELEPHONE CORPORATION, Tokyo (JP)

(21) Appl. No.: 18/015,680

(22) PCT Filed: Jul. 15, 2020
(86) PCT No.: PCT/JP2020/027564

§ 371 Date: Jan. 11, 2023

(51) Int. Cl. H04J 14/02

(52) U.S. Cl. CPC H04J 14/0227; H04J 14/0201

(57) ABSTRACT

A communication device that is connected to a wavelength-multiplexed optical ring network and conducts communication by performing time-division multiplexing on an optical signal for each wavelength includes: a communication unit that transmits a requested transmission amount for requesting a transmission band to a master communication device, and receives an allowed transmission amount for allocating a transmission band from the master communication device; and a control unit that estimates a band utilization rate of each wavelength on the basis of the requested transmission amount and the allowed transmission amount, and allocates data to the respective wavelengths so as to equalize the band utilization rates among the wavelengths. Thus, it is possible to equalize band utilization rates among wavelengths, and enhance communication efficiency of the entire system.

### TECHNICAL FIELD

The present invention relates to a technology for conducting communication by performing time-division multiplexing on optical signals for each wavelength in a wavelength-multiplexed optical ring network that forms a communication system.

### BACKGROUND ART

A conventional optical ring network system conducts communication by multiplexing optical signals having wavelengths allocated beforehand to a plurality of optical transmission devices connected to an optical ring network by an optical add-drop multiplexer (OADM) technology (see Non Patent Literature 1, for example).

On the other hand, there is a known optical burst ring network technology for transmitting optical signals by time-division multiplexing, instead of OADM. By this technology, one optical transmission among a plurality of optical transmission devices connected to an optical ring network operates as a master device, and the other optical transmission devices operate as slave devices. The master device controls the data transmission timings for all the devices including the master device.

Meanwhile, as for a bandwidth allocation technology in Gigabit Ethernet (registered trademark)—Passive Optical Network (GE-PON), dynamic bandwidth allocation (DBA), priority control, and the like have been studied (see Non Patent Literature 2, for example). Further, a low-delay DBA technology in time division multiplexing (TDM)-PON has been studied (see Non Patent Literature 3, for example).

### CITATION LIST

### Non Patent Literature

Non Patent Literature 1: Sakamaki et al., “Optical Switch Technology for Obtaining More Flexible Optical Nodes”, NTT Technology Journal, November 2013
(https://www.ntt.co.jp/journal/1311/files/jn201311016.pdf)
Non Patent Literature 2: T. Tatsuta et al., “Design philosophy and performance of a GE-PON system for mass Deployment”, Journal of Optical Networking, vol. 6, no. 6, pp689-700, 2007.
Non Patent Literature 3: S. Hatta et al., “Implementation of ultra-low latency dynamic bandwidth allocation method for TDM-PON”, IEICE Communication Express, vol. 5, no. 11, pp418-423, 2016.

### SUMMARY OF INVENTION

### Technical Problem

In a case where a plurality of optical transmission devices connected to a wavelength-multiplexed optical ring network performs DBA, a slave device transmits, to the master device, a report message for notifying the master device of the amount of data that is stored in a buffer and is scheduled to be transmitted, and requesting a transmission band (a requested transmission amount). On the basis of the report messages received from the plurality of slave devices, the master device transmits a gate message for allocating a transmission band to each slave device (an allowed transmission amount). As a result, it becomes possible to allocate transmission bands in accordance with the amounts of data in the buffers of the slave devices.

However, data received from an external NW is allocated to the respective buffers provided for the respective wavelengths, regardless of the band utilization rates of the respective wavelengths. For this reason, the band utilization rates among the wavelengths are not equalized, and waste is caused in terms of communication efficiency.

The present invention aims to provide a communication device, communication method, a communication system, and a communication program that can enhance communication efficiency of an entire system by equalizing band utilization rates among wavelengths, when connected to a wavelength-multiplexed optical ring network and conducting communication by performing time-division multiplexing on optical signals for the respective wavelengths.

### Solution to Problem

A communication device according to the present invention is connected to a wavelength-multiplexed optical ring network, and conducts communication by performing time-division multiplexing on an optical signal for each wavelength. The communication device includes: a communication unit that transmits a requested transmission amount for requesting a transmission band to a master communication device, and receives an allowed transmission amount for allocating a transmission band from the master communication device; and a control unit that estimates a band utilization rate of each wavelength on the basis of the requested transmission amount and the allowed transmission amount, and allocates data to the respective wavelengths so as to equalize the band utilization rates among the wavelengths.

The present invention also relates to a communication method implemented in a communication system that conducts communication by performing time-division multiplexing on an optical signal for each wavelength via a wavelength-multiplexed optical ring network to which a master communication device and a slave communication device are connected. The master communication device receives a requested transmission amount for requesting a transmission band from a plurality of the slave communication devices, and transmits an allowed transmission amount for allocating a transmission band to each of the slave communication devices. The slave communication device estimates a band utilization rate of each wavelength on the basis of the requested transmission amount transmitted to the master communication device and the allowed transmission amount received from the master communication device, and allocates data to the respective wavelengths so as to equalize the band utilization rates among the wavelengths.

The present invention also relates to a communication system that conducts communication by performing time-division multiplexing on an optical signal for each wavelength via a wavelength-multiplexed optical ring network to which a master communication device and a slave communication device are connected. The master communication device receives a requested transmission amount for requesting a transmission band from a plurality of the slave communication devices, and transmits an allowed transmission amount for allocating a transmission band to each of the slave communication devices. The slave communication device estimates a band utilization rate of each wavelength on the basis of the requested transmission amount transmitted to the master communication device and the allowed transmission amount received from the master communication device, and allocates data to the respective wavelengths so as to equalize the band utilization rates among the wavelengths.

Further, a communication program according to the present invention causes a computer or an integrated circuit to perform the processes that are performed by the control unit of the communication device described above.

### Advantageous Effects of Invention

A communication device, a communication method, a communication system, and a communication program according to the present invention can enhance communication efficiency of the entire system by equalizing the band utilization rates among wavelengths, when connected to a wavelength-multiplexed optical ring network and conducting communication by performing time-division multiplexing on optical signals for the respective wavelengths.

### BRIEF DESCRIPTION OF DRAWINGS

FIG. 1 is a diagram illustrating an example of an optical ring network system according to an embodiment.

FIG. 2 is a diagram illustrating an example configuration of an optical transmission device operating as a slave device.

FIG. 3 is a flowchart showing an example of a data allocation weighting process in an optical transmission device operating as a slave device.

FIG. 4 is a diagram illustrating an optical ring network system of a comparative example.

FIG. 5 is a diagram illustrating the configuration of an optical transmission device of the comparative example.

### DESCRIPTION OF EMBODIMENTS

The following is a description of an embodiment of a communication device, a communication method, a communication system, and a communication program according to the present invention, with reference to the drawings. Note that the embodiment concerns an optical ring network system (corresponding to the communication system) that includes a plurality of optical transmission devices (corresponding to the communication devices) connected via an optical ring network.

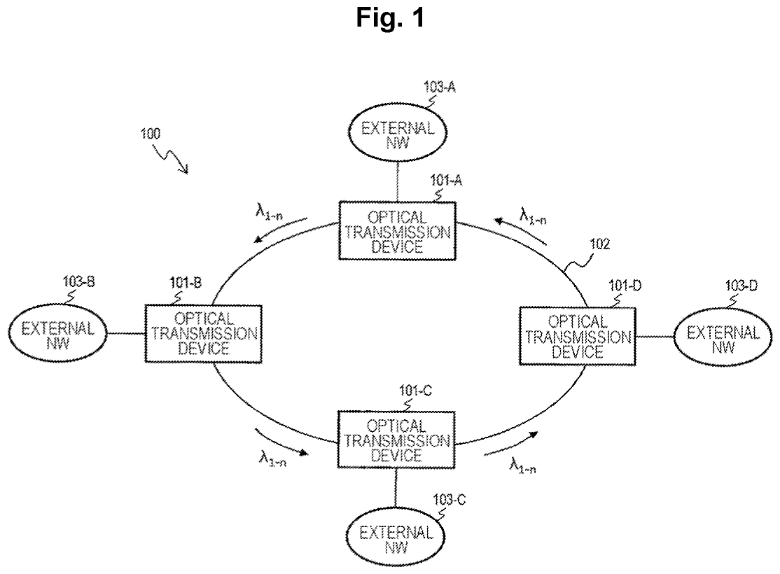

FIG. 1 illustrates an example of an optical ring network system 100 according to the embodiment.

In the example illustrated in FIG. 1, an optical transmission device 101-A, an optical transmission device 101-B, an optical transmission device 101-C, and an optical transmission device 101-D are connected by a ring-like network (an optical ring network 102) formed with optical fibers.

In a case where an explanation common to the optical transmission device 101-A, the optical transmission device 101-B, the optical transmission device 101-C, and the optical transmission device 101-D is made herein, the alphabet at the end of each reference numeral is omitted, and each optical transmission device is referred to as the optical transmission device 101. In a case where a specific device among the plurality of optical transmission devices 101 is described, the specific device is referred to as the optical transmission device 101-A, for example, with an alphabet added at the end of reference numeral. The same applies to an external network (NW) 103-A, an external NW 103-B, an external NW 103-C, and an external NW 103-D.

The external NWs 103 are connected to the respective optical transmission devices 101, and communication between these external NWs 103 can be performed via the optical ring network 102. Here, data received from an external NW 103 is allocated to optical signals of a plurality of wavelengths to be subjected to wavelength multiplexing, and is transmitted to the optical transmission device 101 as the communication destination.

The external NWs 103 are NWs connected to the optical ring network system 100 mentioned above, and have NW devices or the like connected thereto.

Here, the optical ring network system 100 according to the embodiment performs wavelength multiplexing on optical signals, to conduct communication. For example, in FIG. 1, optical signals of n (n being a positive integer) wavelengths of λ₁₋ₙ are subjected to wavelength multiplexing.

Further, the optical ring network system 100 uses an optical burst ring network technology. By this technology, the plurality of optical transmission devices 101 performs time-division multiplexing (optical time division multiple access (TDMA)) on optical signals of the respective wavelengths, to conduct communication in the optical ring network 102.

In FIG. 1, of the plurality of optical transmission devices 101, one optical transmission device 101 operates as the master device (corresponding to the master communication device), and the other optical transmission devices 101 operate as slave devices (corresponding to the slave communication devices). The master device controls the optical signal transmission timings for all the devices for each wavelength. Here, the master device in the initial state is determined in advance. For example, in a case where the optical transmission device 101-A is the master device, the optical transmission device 101-B, the optical transmission device 101-C, and the optical transmission device 101-D are the slave devices. Note that each slave device may have a function of causing one of the slave devices to operate as the new master device in a case where a failure occurs in the master device.

In FIG. 1, an optical transmission device 101 as a slave device (the optical transmission device 101-B, for example) transmits a report message for requesting a transmission band to the optical transmission device 101 as the master device (the optical transmission device 101-A, for example) (a requested transmission amount). The optical transmission device 101 as the master device (the optical transmission device 101-A, for example) then transmits a gate message for allocating a transmission band to the optical transmission device 101 as a slave device (the optical transmission device 101-B, for example) (an allowed transmission amount).

The optical transmission device 101 as a slave device then estimates a band utilization rate for each wavelength, on the basis of the requested transmission amount transmitted to the master device for each wavelength and the allowed transmission amount received from the master device. The optical transmission device 101 as a slave device allocates the data received from the external NW 103 to the buffers corresponding to the respective wavelengths, so that the band utilization rates among the wavelengths are equalized.

In this manner, each optical transmission device 101 as a slave device according to the embodiment estimates a band utilization rate for each wavelength on the basis of the requested transmission amount and the allowed transmission amount, and performs weighting on the amount of data to be allocated to the buffers of the respective wavelengths so that the band utilization rates among the wavelengths are equalized. As a result, the optical ring network system 100 according to the embodiment can preferentially allocate data to buffers of wavelengths having low band utilization rates, and thus, can equalize the band utilization rates among the wavelengths and enhance communication efficiency in the entire system.

(Example Configuration of an Optical Transmission Device 101)

The four optical transmission devices 101 described with reference to FIG. 1 each have the functions of both a master device and a slave device, and can select the functions of either one, to operate as a master device or a slave device. For example, in a case where the functions of a master device are selected, the optical transmission device 101-A operates as the master device, and, in a case where the functions of a slave device are selected, the optical transmission device 101-A operates as a slave device.

Here, in the description below, the optical transmission device 101-A operates as the master device, and the optical transmission device 101-B, the optical transmission device 101-C, and the optical transmission device 101-D operate as the slave devices.

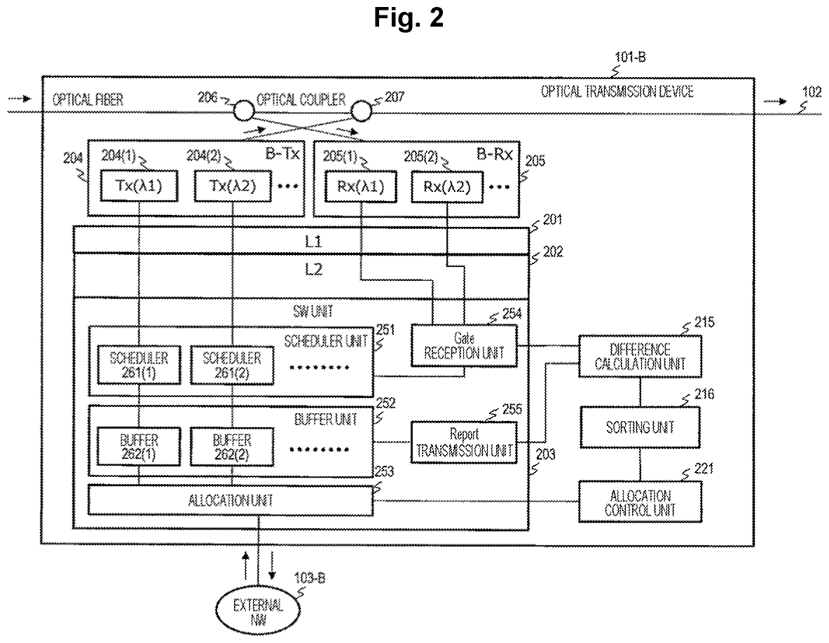

FIG. 2 illustrates an example configuration of the optical transmission device 101-B operating as a slave device illustrated in FIG. 1. Note that the optical transmission device 101-C and the optical transmission device 101-D operating as the same slave devices as the optical transmission device 101-B operate in the same manner as the optical transmission device 101-B.

In FIG. 2, the optical transmission device 101-B includes a layer-1 processing unit (L1 unit) 201, a layer-2 processing unit (L2 unit) 202, a switch unit (SW unit) 203, an optical transmission unit (B-Tx unit) 204, an optical reception unit (B-Rx unit) 205, an optical coupler 206, an optical coupler 207, a difference calculation unit 215, a sorting unit 216, and an allocation control unit 221.

The L1 unit 201 has a function of processing an OSI-reference-model first layer (a physical layer).

The L2 unit 202 has a function of processing an OSI-reference-model second layer (a data link layer). The L2 unit 202 also has a function for operating as a master device and a function for operating as a slave device, and can select one of the functions by setting. For example, the L2 unit 202 of the optical transmission device 101-A as the master device operates as the master device, and the L2 unit 202 of the optical transmission device 101-B as a slave device operates as a slave device. Note that, in the case of a slave device, a function of detecting a failure in the master device may be provided, and the slave device may operate as the new master device when a failure is sensed in the master device.

The SW unit 203 is an electric packet switch such as a L2-SW connected to the external NW 103-B, and has a function of processing a packet transfer between the L2 unit 202 and the external NW 103-B in accordance with preset rules. Note that the configuration of the SW unit 203 will be described later in detail.

The B-Tx unit 204 is a transmission unit that intermittently outputs an optical signal, and transmits a signal transferred from the L1 unit 201 as an optical signal to an optical fiber via an optical coupler in a burst manner. The B-Tx unit 204 also has a transmission unit (Tx) for each wavelength of the plurality of wavelengths. For example, the B-Tx unit 204 includes a Tx 204(1) of the wavelength λ1, a Tx 204(2) of the wavelength λ2 . . . , and a Tx 204(n) (not shown) of the wavelength λn. For example, the Tx 204(1) transmits a signal transferred from the L1 unit 201 as an optical signal of the wavelength λ1 in a burst manner.

The B-Rx unit 205 is a reception unit that intermittently receives an optical signal, receives an optical signal from an optical fiber in a burst manner via an optical coupler, and transfers the signal to the L1 unit 201. The B-Rx unit 205 also has a reception unit (Rx) for each wavelength of the plurality of wavelengths. For example, the B-Rx unit 205 includes a Rx 205(1) of the wavelength λ1, a Rx 205(2) of the wavelength λ2, . . . , and a Rx 205(n) (not shown) of the wavelength λ2n. For example, the Rx 205(1) receives an optical signal from an optical fiber in a burst manner, and transfers the signal to the L1 unit 201. Here, the B-Tx unit 204 and the B-Rx unit 205 correspond to the communication unit.

The optical coupler 206 and the optical coupler 207 each have a function of branching the power of an input optical signal.

(Example Configuration of the SW Unit 203)

Referring to FIG. 2, an example configuration of the SW unit 203 according to the embodiment is described. The SW unit 203 includes a scheduler unit 251, a buffer unit 252, an allocation unit 253, a gate reception unit 254, and a report transmission unit 255.

The scheduler unit 251 includes a scheduler 261 for each wavelength, and transmits the data stored in the buffer unit 252, on the basis of a gate message received from the master device by the gate reception unit 254 described later. Specifically, each scheduler 261 transmits, from the B-Tx unit 204, the data stored in the buffer 262 of the corresponding wavelength at the transmission timing for the transmission time designated by the gate message. For example, transmission at a wavelength λ1 is handled by the scheduler 261(1), and transmission at a wavelength λ2 is handled by the scheduler 261(2). Here, transmission speed×transmission time=the allowed transmission amount, and the slave device can obtain the allowed transmission amount on the basis of the transmission timing and the transmission time shown in a gate message from the master device. Alternatively, the master device may directly notify the slave device of the allowed transmission amount.

The buffer unit 252 includes a buffer 262 for each wavelength, and stores the data allocated to the respective wavelengths by the allocation unit 253. For example, the wavelength λ1 corresponds to the buffer 262(1), and the wavelength λ2 corresponds to the buffer 262(2). Here, the amount of the data stored in the buffer 262 of each wavelength is acquired by the report transmission unit 255 described later.

The allocation unit 253 allocates transmission data input from the external NW 103-B to the buffers 262 of the respective wavelengths. In the embodiment, the allocation unit 253 allocates the transmission data input from the external NW 103-B to the buffers 262 of the respective wavelengths at ratios weighted by the allocation control unit 221. Here, the method for allocating the data received from the external NW 103-B may be weighted RR (WRR) or the like by which weighting is performed before data allocation, for example. Alternatively, an allocation method other than WRR may be used.

The gate reception unit 254 receives a gate message transmitted from the optical transmission device 101-A as the master device to the slave device, and outputs the gate message to the scheduler unit 251 and the difference calculation unit 215. Here, the master device may transmit a gate message for each wavelength, or may transmit gate messages for the respective wavelengths as one gate message. Note that the gate message is output to the scheduler unit 251 and the difference calculation unit 215.

The report transmission unit 255 acquires the amount of the data accumulated in the buffer 262 of each wavelength, notifies the master device of the amounts of data as the requested transmission amount through a report message, and outputs the amount of data to difference calculation unit 215. Note that the report transmission unit 255 may transmit a report message for each wavelength to the master device, or may transmit report messages for the respective wavelengths as one report message to the master device. The report message is transmitted to the master device via the buffer unit 252 and the scheduler unit 251.

The difference calculation unit 215 calculates a difference Δ between the requested transmission amount shown in the report message transmitted to the master device and the allowed transmission amount shown in the gate message received from the master device for each wavelength (Equation (1)).

DifferenceΔ=requested transmission amount−allowed transmission amount (1)

Here, in a case where three wavelengths that are a difference Δ1 of the wavelength λ1, a difference Δ2 of the wavelength λ2, and a difference Δ3 of the wavelength λ3 are used, for example, the following list can be created in the order of wavelengths for the difference Δ of each wavelength.

| (Wavelength) | (Difference) |
|---|---|
| λ1 | Δ1 |
| λ2 | Δ2 |
| λ3 | Δ3 |

The sorting unit 216 has a function of rearranging the list on the basis of the magnitudes of the differences Δ calculated by the difference calculation unit 215. For example, in the above list, the magnitudes of the differences Δ may be in the relationship: Δ3>Δ2>Δ1. In this case, the sorting unit 216 rearranges the list of wavelengths in descending order of the differences Δ as follows.

| (Wavelength) | (Difference) |
|---|---|
| λ3 | Δ3 (large) |
| λ2 | Δ2 (intermediate) |
| λ1 | Δ1 (small) |

Here, at the wavelength having a large difference Δ, a sufficient allowed transmission amount is not allocated for the requested transmission amount, and a large amount of data is stored in the buffer 262 of the wavelength. Therefore, the band utilization rate is lower than that at a wavelength having a small difference Δ. That is, the larger the difference Δ of a wavelength, the lower its band utilization rate. The smaller the difference Δ of a wavelength, the higher its band utilization rate.

The allocation control unit 221 performs weighting when the allocation unit 253 allocates the data received from the external NW 103 to the buffer 262 of each wavelength, in accordance with the order rearranged by the sorting unit 216. The weighting is performed so that a wavelength with a small difference Δ (a high band utilization rate) is lightly weighted, and a wavelength with a large difference Δ (a low band utilization rate) is heavily weighted. In the example shown below, weighting is performed as follows: the sum of weight coefficients is 1, the weight coefficient of the wavelength λ3 with the largest difference Δ is 0.6, the weight coefficient of the wavelength λ2 with the second largest difference Δ is 0.3, and the weight coefficient of the wavelength λ1 with the smallest difference Δ is 0.1.

| (Wavelength) | (Difference) | (Weight coefficient) |
|---|---|---|
| λ3 | Δ3 | 0.6 |
| λ2 | Δ2 | 0.3 |
| λ1 | Δ1 | 0.1 |

Here, in the above example, the data received from the external NW 103 is allocated to the respective buffers 262 of the wavelengths λ3, λ2, and λ1 at a ratio of 6 packets: 3 packets: 1 packet, for example.

In this manner, the optical transmission device 101 operating as a slave device estimates a band utilization rate for each wavelength on the basis of the requested transmission amount and the allowed transmission amount, and performs weighting on the amount of data to be allocated to the buffers 262 of the respective wavelengths so that the band utilization rates among the wavelengths are equalized. As a result, the amount of data to be allocated to the buffer 262 of a wavelength with a high band utilization rate is reduced, and the amount of data to be allocated to the buffer 262 of a wavelength with a low band utilization rate is increased. Thus, the band utilization rates among the wavelengths are equalized, and the communication efficiency of the entire system becomes higher.

Note that, in the above embodiment, the case of an optical transmission device 101 operating as a slave device has been described. However, the embodiment can also be applied to an optical transmission device 101 operating as the master device. In this case, the master device calculates a difference Δ between the amount of data stored in the buffer of the subject device and the allowed transmission amount allocated to the subject device for each wavelength, weights the data received from the external NW 103 connected to the subject device, and allocates the data to the buffer of each wavelength.

(Data Allocation Weighting Process)

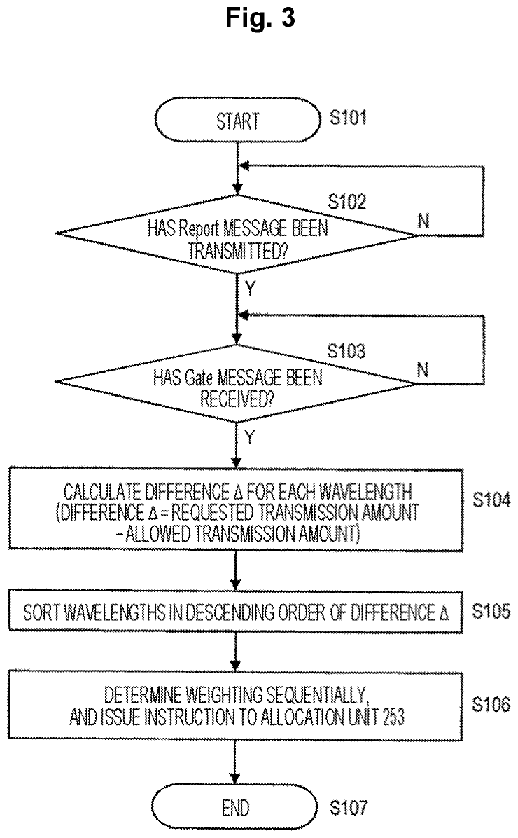

FIG. 3 illustrates an example of a data allocation weighting process in an optical transmission device 101 operating as a slave device. Here, the process in FIG. 3 is performed by the difference calculation unit 215, the sorting unit 216, the allocation control unit 221, the gate reception unit 254, the report transmission unit 255, and the like in the optical transmission device 101-B as a slave device described above with reference to FIG. 2, for example. Note that a program corresponding to the process to be described with reference to FIG. 3 may be performed by a computer or an integrated circuit such as a field programmable gate array (FPGA). Alternatively, the program may be recorded in a storage medium to be provided, or may be provided through a network.

In step S101, the optical transmission device 101 operating as a slave device starts a process of performing weighting when allocating data received from the external NW 103.

In step S102, the report transmission unit 255 transmits, to the master device, a report message for issuing a notification of the amount of data that is stored in the buffers 262 and is scheduled to be transmitted (the requested transmission amount) and requesting a transmission band. Because a report message is transmitted to the master device at a predetermined transmission timing, there is a standby time till the transmission timing. After the transmission of the report message, the process moves on to step S103.

In step S103, the gate reception unit 254 determines whether a gate message for notifying each slave device of the transmission band (the allowed transmission amount) has been received from the master device. If a gate message has been received (Y), the process moves on to step S104. If any gate message has not been received (N), the process stays in step S103 until a gate message is received.

In step S104, on the basis of the requested transmission amount transmitted to the master device in step S102 and the allowed transmission amount received from the master device in step S103, the difference calculation unit 215 calculates a difference Δ for each wavelength as described above with reference to Equation (1).

In step S105, the sorting unit 216 rearranges the list of differences Δ based on wavelengths, in descending order of the differences Δ.

In step S106, in accordance with the order rearranged in step S105, the allocation control unit 221 determines the weights to be used by the allocation unit 253 in allocating the data received from the external NW 103 to the buffers 262 of the respective wavelengths. The allocation control unit 221 then instructs the allocation unit 253 to allocate the data received from the external NW 103 to the buffers 262 of the respective wavelengths, on the basis of the determined weights.

In step S107, the optical transmission device 101 operating as a slave device ends the process of performing weighting when allocating the data received from the external NW 103.

Note that, while the optical transmission device 101 is operating, the processes from step S102 to step S106 are repeatedly performed, and the weights are changed as the differences Δ change.

Here, as for the relationship between the band utilization rates and the differences Δ, in a case where the requested transmission amount is 100, and the allowed transmission amount is 80, the band utilization rate is 80%, and the difference Δ is 20, for example. Likewise, in a case where the requested transmission amount is 100, and the allowed transmission amount is 20, the band utilization rate is 20%, and the difference Δ is 80. That is, the larger the difference Δ, the lower the band utilization rate. The smaller the difference Δ, the higher the band utilization rate. Therefore, to equalize the band utilization rates among the wavelengths, the optical transmission device 101 according to the embodiment gives a greater weight to a wavelength with a lower band utilization rate, and gives a smaller weight to a wavelength with a higher band utilization rate.

As described above, the optical transmission device 101 operating as a slave device according to the embodiment calculates the difference Δ between the requested transmission amount and the allowed transmission amount for each wavelength, weights the data received from the external NW 103 on the basis of the magnitudes of the differences Δ, and allocates the data to the buffers 262 of the respective wavelengths. Accordingly, priority is given to allocation of data to the buffer 262 of a wavelength with a large difference Δ (a low band utilization rate), and the amount of data to be allocated to the buffer 262 of a wavelength with a small difference Δ (a high band utilization rate) decreases. As a result, the band utilization rates among the wavelengths are equalized, and the communication efficiency of the entire system becomes higher.

### COMPARATIVE EXAMPLE

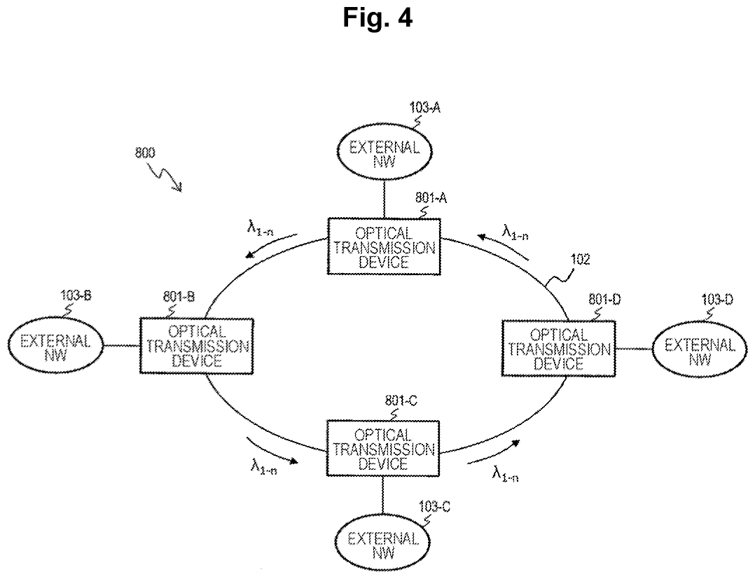

FIG. 4 illustrates an optical ring network system 800 of a comparative example. Note that, in FIG. 4, blocks denoted by the same reference numerals as those in FIG. 1 operate in the same manner as those in FIG. 1.

In the comparative example in FIG. 4, an optical transmission device 801-A, an optical transmission device 801-B, an optical transmission device 801-C, and an optical transmission device 801-D are connected by an optical ring network 102. Further, an external NW 103 is connected to each optical transmission device 801. Here, the optical ring network 102 that is wavelength-multiplexed and the external NWs 103 are the same as those of the optical ring network system 100 of the embodiment described with reference to FIG. 1.

Like the optical ring network system 100 in FIG. 1, the optical ring network system 800 of the comparative example is an optical burst ring network system that performs time-division multiplexing on optical signals for each wavelength, and can perform dynamic bandwidth allocation.

In the optical ring network system 800 of the comparative example, each optical transmission device 801 allocates data received from the external NW 103 to the buffers of the respective wavelengths, regardless of the band utilization rates of the respective wavelengths. Therefore, there is a possibility that a wasted portion will appear in terms of communication efficiency. For example, even in a case where the band utilization rate of the wavelength λ1 is higher than the band utilization rate of the wavelength λ2, the data received from the external NW 103 is allocated to the buffer of the wavelength λ1 and the buffer of the wavelength λ2. Therefore, the load on the wavelength λ1 having a higher band utilization rate than the wavelength λ2 becomes larger.

In the optical ring network system 100 according to the embodiment, on the other hand, each optical transmission device 101 estimates a band utilization rate, and determines the weights to be used in allocating the data received from the external NW 103 to the buffers of the respective wavelengths. For example, in a case where the band utilization rate of the wavelength λ1 is higher than the band utilization rate of the wavelength weighting is performed so that a larger amount of the data received from the external NW 103 is allocated to the buffer of the wavelength λ2 having a lower band utilization rate. As a result, the band utilization rates of the wavelength λ1 and the wavelength λ2 are equalized, and thus, the communication efficiency of the entire system becomes higher.

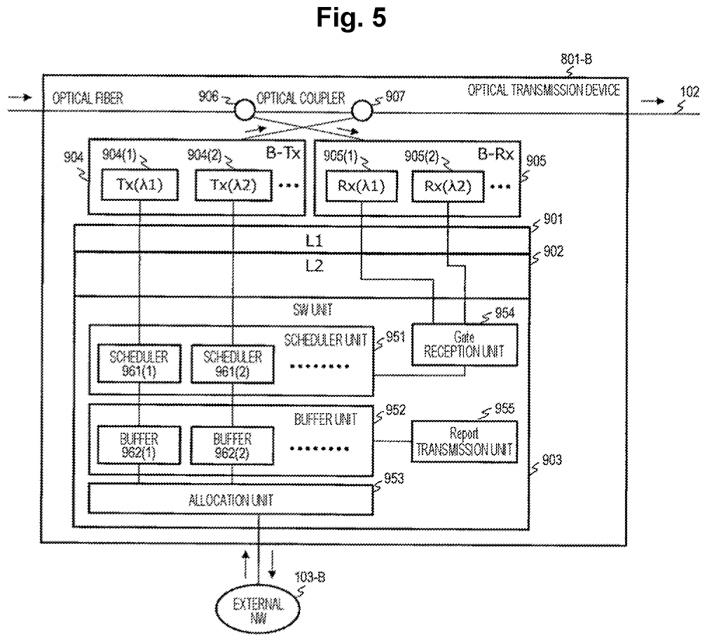

FIG. 5 illustrates the configuration of the optical transmission device 801-B that operates as a slave device in the comparative example illustrated in FIG. 4. Note that the optical transmission device 801-C and the optical transmission device 801-D operate in the same manner as the optical transmission device 801-B. Here, in FIG. 4, the optical transmission device 801-A operates as the master device, and the optical transmission device 801-B, the optical transmission device 801-C, and the optical transmission device 801-D operate as the slave devices. Like the optical transmission device 101-B as a slave device described with reference to FIG. 2, the optical transmission device 801-B as a slave device transmits and receives a report message and a gate message to and from the master device. The optical transmission device 801-B as a slave device then transmits the data stored in the buffer of each wavelength by the allowed transmission amount shown in the gate message from the master device.

In FIG. 5, the optical transmission device 801-B includes a L1 unit 901, a L2 unit 902, a SW unit 903, a B-Tx unit 904, a B-Rx unit 905, an optical coupler 906, and an optical coupler 907. Here, the basic functions of the optical transmission device 801-B are the same as those of the L1 unit 201, the L2 unit 202, the SW unit 203, the B-Tx unit 204, the B-Rx unit 205, the optical coupler 206, and the optical coupler 207 of the optical transmission device 101-B according to the embodiment described above with reference to FIG. 2.

The differences from the optical transmission device 101-B according to the embodiment are as follows. The optical transmission device 101-B according to the embodiment includes the difference calculation unit 215, the sorting unit 216, and the allocation control unit 221, but the optical transmission device 801-B of the comparative example does not. Therefore, operations of an allocation unit 953, a gate reception unit 954, and a report transmission unit 955 of the SW unit 903 are slightly different from those of the SW unit 203 according to the embodiment illustrated in FIG. 2.

The allocation unit 953 simply allocates the transmission data input from the external NW 103-B sequentially to the buffers 962 of the respective wavelengths in the buffer unit 952. In the embodiment in FIG. 2, on the other hand, the allocation unit 253 weights the transmission data input from the external NW 103-B at the ratio designated by the allocation control unit 221, and allocates the transmission data to the buffers 262 of the respective wavelengths.

The gate reception unit 954 receives a gate message transmitted from the master device to the slave device for each wavelength, and outputs, to the scheduler unit 251, the transmission timing and the transmission time shown in the gate message.

The report transmission unit 955 reads the amount of data stored in the buffer 262 of each wavelength, and transmits a report message showing the amount of data of each wavelength as a requested transmission amount to the master device.

As described above, the optical transmission device 801-B of the comparative example notifies the master device of the data amount of the buffer 962 of each wavelength through a report message, and simply transmits the data stored in the buffers 962 of the respective wavelengths on the basis of a gate message received from the master device. Therefore, the data received from the external NW 103-B is allocated to the buffers 962 of the respective wavelengths, regardless of the band utilization rates of the respective wavelengths. Because of this, waste will be caused in terms of communication efficiency, in a case where the band utilization rates among the wavelengths are different.

In the optical ring network system 100 according to the embodiment described with reference to FIGS. 1 to 3, on the other hand, each optical transmission device 101 operating as a slave device estimates a band utilization rate for each wavelength, on the basis of a requested transmission amount and an allowed transmission amount. The optical transmission device 101 then performs weighting for allocating data to the buffers 262 of the respective wavelengths so that the band utilization rates among the wavelengths are equalized. Thus, the communication efficiency of the entire system becomes higher.

As described so far, a communication device, a communication method, a communication system, and a communication program according to the present invention can equalize the band utilization rates among the wavelengths, and enhance the communication efficiency of the entire system.

### REFERENCE SIGNS LIST

100, 800 optical ring network system
101, 801 optical transmission device
102 optical ring network
103 external NW
201, 901 L1 unit
202, 902 L2 unit
203, 903 SW unit
204, 904 B-Tx unit
205, 905 B-Rx unit
206, 207, 906, 907 optical coupler
215 difference calculation unit
216 sorting unit
221 allocation control unit
251, 951 scheduler unit
252, 952 buffer unit
253, 953 allocation unit
254, 954 gate reception unit
255, 955 report transmission unit
261, 961 scheduler
262, 962 buffer

1. A communication device that is connected to a wavelength-multiplexed optical ring network, and conducts communication by performing time-division multiplexing on an optical signal for each wavelength,
the communication device comprising:
a communication unit that transmits a requested transmission amount for requesting a transmission band to a master communication device, and receives an allowed transmission amount for allocating a transmission band from the master communication device; and
a control unit that estimates a band utilization rate of each wavelength on a basis of the requested transmission amount and the allowed transmission amount, and allocates data to the respective wavelengths to equalize band utilization rates among the wavelengths.

2. The communication device according to claim 1, wherein
the control unit includes:
a difference calculation unit that calculates a difference between the requested transmission amount and the allowed transmission amount for each wavelength;
a sorting unit that rearranges a list of the differences for the respective wavelengths in descending order of the differences; and
an allocation control unit that performs weighting on an amount of data to be allocated to the buffer of each wavelength in descending order of the differences rearranged by the sorting unit, and allocates the data to the buffers of the respective wavelengths.

3. A communication method implemented in a communication system that conducts communication by performing time-division multiplexing on an optical signal for each wavelength via a wavelength-multiplexed optical ring network to which a master communication device and a slave communication device are connected,
wherein
the master communication device receives a requested transmission amount for requesting a transmission band from a plurality of the slave communication devices, and transmits an allowed transmission amount for allocating a transmission band to each of the slave communication devices, and
the slave communication device estimates a band utilization rate of each wavelength on a basis of the requested transmission amount transmitted to the master communication device and the allowed transmission amount received from the master communication device, and allocates data to the respective wavelengths to equalize band utilization rates among the wavelengths.

4. The communication method according to claim 3, wherein
the slave communication device
calculates a difference between the requested transmission amount and the allowed transmission amount for each wavelength,
rearranges a list of the differences for the respective wavelengths in descending order of the differences, and
performs weighting on an amount of data to be allocated to the buffer of each wavelength in descending order of the rearranged differences, and allocates the data to the buffers of the respective wavelengths.

5. A communication system that conducts communication by performing time-division multiplexing on an optical signal for each wavelength via a wavelength-multiplexed optical ring network to which a master communication device and a slave communication device are connected,
wherein
the master communication device receives a requested transmission amount for requesting a transmission band from a plurality of the slave communication devices, and transmits an allowed transmission amount for allocating a transmission band to each of the slave communication devices, and
the slave communication device estimates a band utilization rate of each wavelength on a basis of the requested transmission amount transmitted to the master communication device and the allowed transmission amount received from the master communication device, and allocates data to the respective wavelengths to equalize band utilization rates among the wavelengths.

6. The communication system according to claim 5, wherein
the slave communication device
calculates a difference between the requested transmission amount and the allowed transmission amount for each wavelength,
rearranges a list of the differences for the respective wavelengths in descending order of the differences, and
performs weighting on an amount of data to be allocated to the buffer of each wavelength in descending order of the rearranged differences, and allocates the data to the buffers of the respective wavelengths.

7. A communication program for causing a computer or an integrated circuit to perform processes that are performed by the control unit of the communication device according to claim 1.
